(19) United States
(12) Patent Application Publication
(10) Pub. No.: US 2005/0083683 A1
(43) Pub. Date: Apr. 21, 2005

(54) Self-generating flashlight

(76) Inventors: Ping-Hui Ho, Sindian City (TW); Wen-Li Chou, Shulin City (TW)

Correspondence Address: RABIN & BERDO, P.C., Suite 500, 1101 14th Street, N.W., Washington, DC, 20005, US

(21) Appl. No.: 10/684,390

(22) Filed: Oct. 15, 2003

(51) Int. Cl. F21L 4/00

(52) U.S. Cl. 362/208

(57) ABSTRACT

A self-generating flashlight mainly includes a housing defining an inner space; a generator set accommodated in the inner space of the housing and including a hand-pull starter cord, and a pull ring connected to an outer end of the starter cord; and a lighting set including a light-emitting body, a control switch, and a control circuit, and is electrically connected to the generator set via one or more electric wires. When the pull ring is pulled, the hand-pulled starter cord is drawn to drive the generator set to generate an electric power, which is supplied via the electric wires to the light-emitting body for the latter to emit light.

### FIELD OF THE INVENTION

The present invention relates to a flashlight, and more particularly to a self-generating flashlight that transforms an input kinetic energy into an electric energy, and can therefore provides lighting effect without using batteries or an external power supply.

### BACKGROUND OF THE INVENTION

FIGS. 1 and 2 are assembled and exploded perspective views, respectively, of a conventional flashlight A1. As shown, the conventional flashlight A1 mainly includes a front cap A2, a lens A3, a reflector A4, a bulb A5, a housing A6, more than one battery A7, and a rear cap A8. The batteries A7 supply power needed by the bulb A5 to emit light. When the batteries A7 are low or exhausted, they must be replaced with new ones, lest the bulb A5 should fail to emit light and make the whole flashlight A1 useless.

The above-structured conventional flashlight A1 has the following drawbacks: (1) it always requires batteries to emit light while the batteries could not be reserved for a prolonged time; (2) the batteries tend to become damaged in a humid environment; (3) the exhausted batteries must discarded that has adverse influence on the environmental protection; (4) the batteries form an additional cost in using the flashlight; (5) the use of chargeable batteries still causes the problem of energy consumption; and (6) the batteries have only very short usable life.

### SUMMARY OF THE INVENTION

A primary object of the present invention is to provide a self-generating flashlight that includes a generator set and high-capacity capacitor, and could emit light when a hand-pulled starter cord connected to the generator set is manually pulled. Therefore, no battery is needed for the flashlight to emit light.

Another object of the present invention is to provide a flashlight that has a self-generating mechanism and includes detachably assembled parts, and can therefore be used as a teaching aid.

A further object of the present invention is to provide a self-generating flashlight that includes a generator set to generate power needed by the flashlight to emit light, and therefore does not need an external power supply.

A still further object of the present invention is to provide a self-generating flashlight that does not require batteries to save a user the cost for batteries, and can therefore be used in humid environments, and does not have the problem of discarded exhausted batteries to endanger the environmental protection.

A still further object of the present invention is to provide a self-generating flashlight that does not consume any existing energy source, and may be repeatedly used to have an extended usable life.

The self-generating flashlight of the present invention is particularly suitable for use in an emergency without the risk of lacking or having insufficient battery power.

Since the flashlight of the present invention does not use any battery, the problems of failing to reserve batteries for a long time or using the batteries in a humid environment, and of discarded batteries endangering the environment can be eliminated. The flashlight of the present invention may be frequently used without consuming existing energy sources or increasing the user's cost of buying batteries. Moreover, the flashlight of the present invention has extended usable life that is not limited by batteries.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a conventional flashlight;

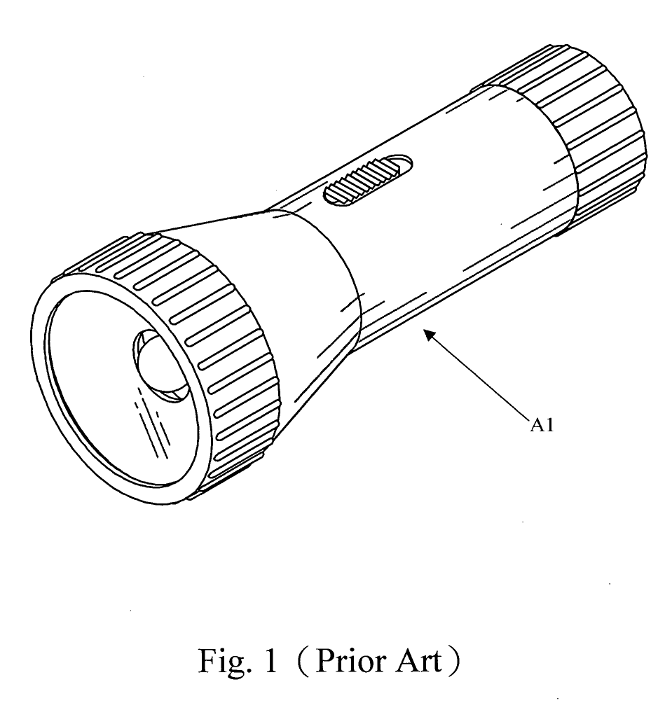

FIG. 2 is an exploded view of FIG. 1;

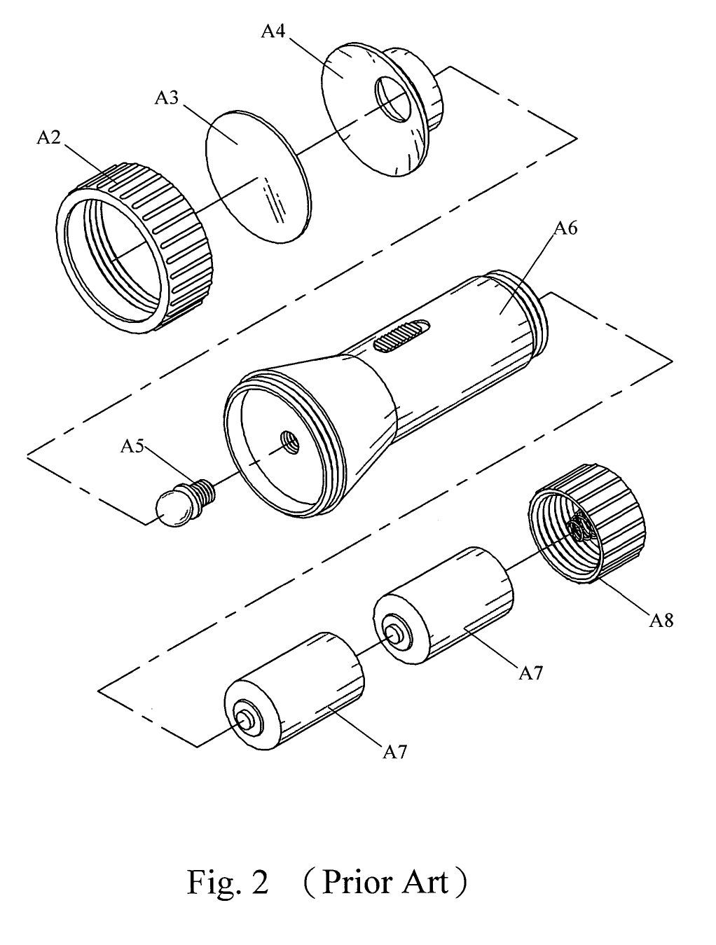

FIG. 3 is a perspective view of a self-generating flashlight according to the present invention;

FIG. 4 is an exploded perspective view of FIG. 3;

FIG. 5 is a fragmentary exploded perspective view of the flashlight of the present invention showing more details thereof;

FIG. 6 is an exploded perspective view of a generator set of the flashlight of the present invention;

FIG. 7 shows the manner of using the flashlight of the present invention;

FIG. 8 shows the manner of charging the flashlight of the present invention;

FIG. 9 shows the opening of an accessory compartment cover on the flashlight of the present invention;

FIG. 10 is a block diagram showing the circuitry of the present invention;

FIG. 11 is a flowchart showing operating procedures of the present invention;

FIG. 12 schematically shows the manner in which the flashlight of the present invention is charged; and

FIG. 13 is a circuit diagram of the flashlight of the present invention.

### DETAILED DESCRIPTION OF THE PREFERRED EMBODIMENTS

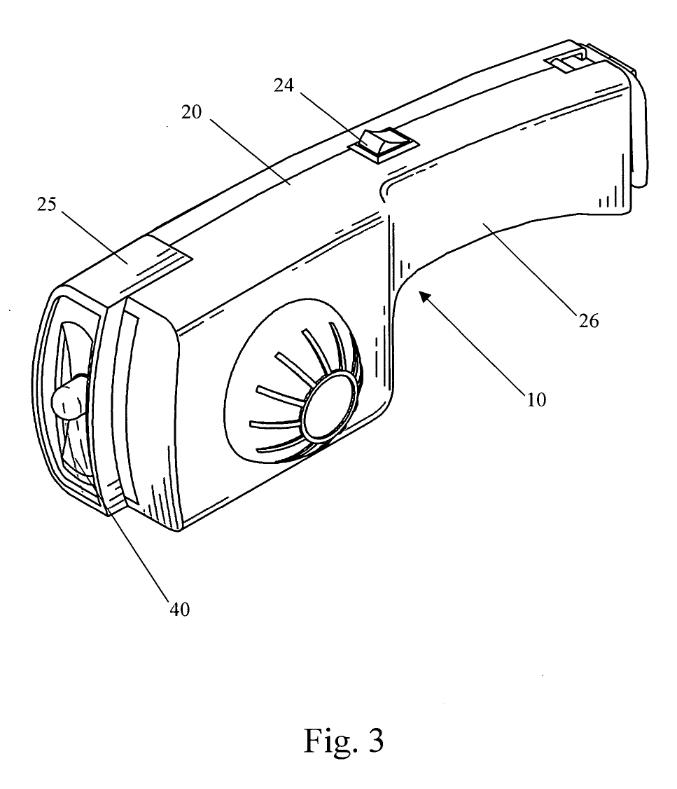

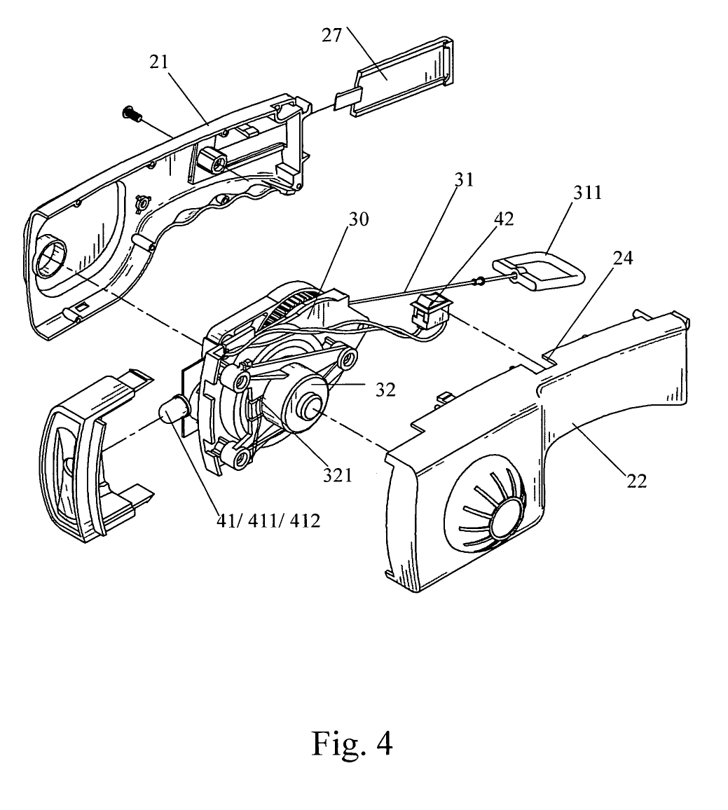

Please refer to FIGS. 3 and 4 that are assembled and exploded perspective views, respectively, of a self-generating flashlight 10 according to the present invention. As shown, the flashlight 10 includes at least a housing 20, a generator set 30, and a lighting set 40.

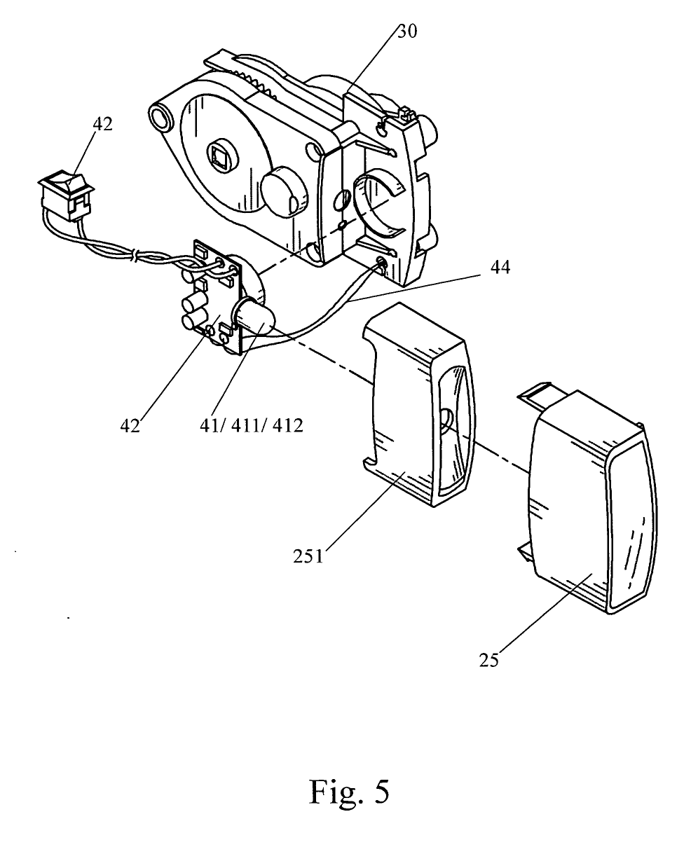

The housing 20 is formed from mated first shell 21 and second shell 22 to define an inner space 23 for accommodating the generator set 30 and the lighting set 40 therein. A control switch opening 24 is provided on the housing 20 at a predetermined position, a lampshade 25 is mounted to a front end of the housing 20, and a rear part of the housing 20 is formed into a handle 26. As can be seen from FIG. 5, a reflection mirror 251 is mounted behind the lampshade 25.

The generator set 30 is mounted in the inner space 23 defined between the first and the second shell 21, 22, and includes a hand-pulled starter cord 31, an outer end of which is connected to a pull ring 311. The pull ring 311 is normally flatly bearing against a rear end of the handle 26.

As can be seen from FIGS. 4 and 5, the lighting set 40 includes a light-emitting body 41, a control switch 42, and a control circuit 43, and is electrically connected to the generator set 30 via more than one electric wire 44. The light-emitting body 41 may be a light-emitting diode 411 or a bulb 412.

When the generator set 30 is mounted in the inner space 23 in the housing 20 and the pull ring 311 is pulled, the hand-pulled starter cord 31 is accordingly drawn to drive the generator set 30, so that the generator set 30 generates an amount of power, which is sent to the lighting set 40 via the electric wires 44 for the light-emitting body 41 to emit light. Light emitted from the light-emitting body 41 is reflected at the reflection mirror to provide an enhanced lighting effect.

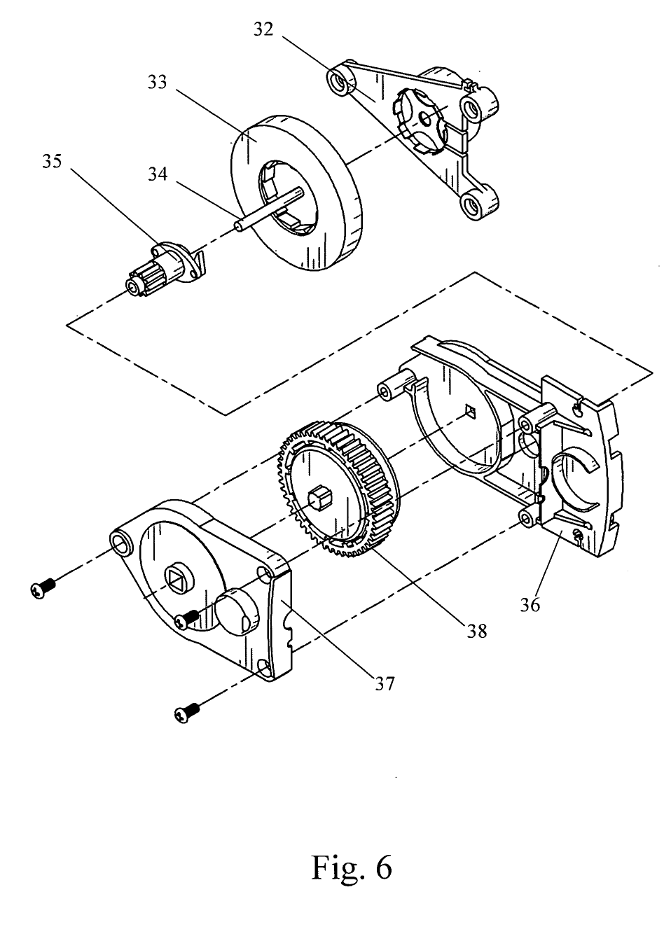

FIG. 6 is an exploded perspective view of the generator set 30 of the flashlight 10. As shown, the generator set 30 mainly includes a power-generating member 32, a flywheel 33, a transmission shaft 34, a relay ratchet 35, a first casing 36, a second casing 37, and a driving wheel 38. Please refer back to FIGS. 4 and 5. The power-generating member 32 includes more than one contact 321, to which the electric wires 44 are connected, so that power generated by the generator set 30 is sent to the control circuit 43 of the lighting set 40 via the electric wires 44.

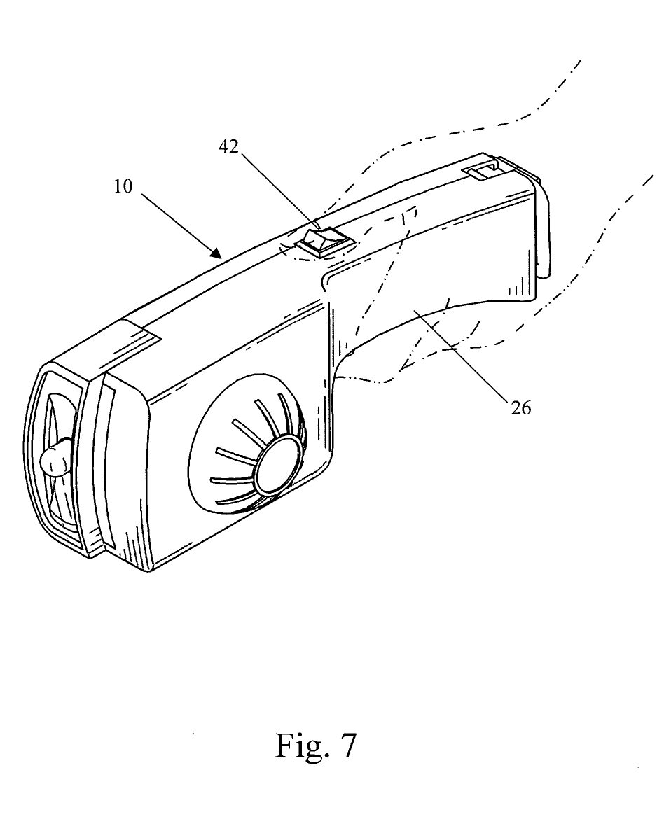

FIG. 7 shows the manner of using the flashlight 10 of the present invention. The control switch 42 is projected from the control switch opening 24 on the housing 20. A user may hold the flashlight 10 at the handle 26 and push the control switch 42 with a thumb to actuate the lighting function of the present invention.

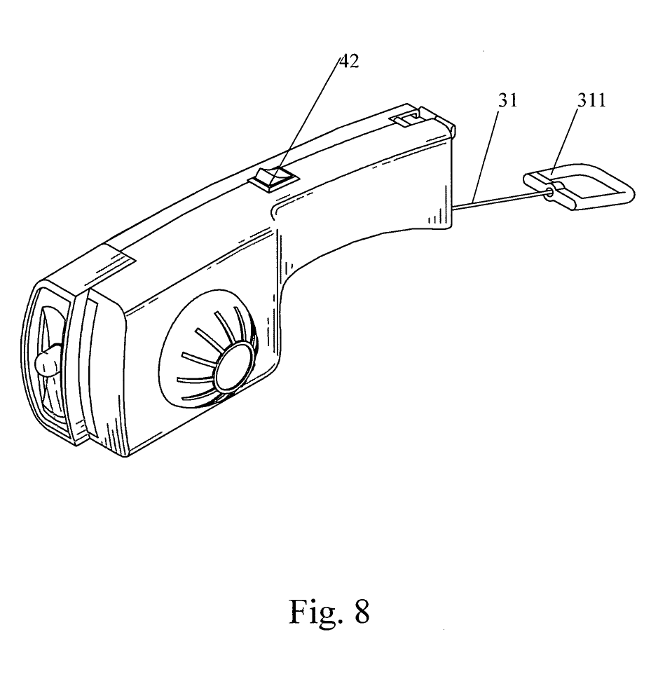

FIG. 8 shows the manner of charging the flashlight 10. Please refer to FIGS. 4 and 8 at the same time. To have the flashlight 10 charged, simply pull the pull ring 311 to draw the hand-pulled starter cord 31 outward, so that a kinetic energy is input to the generator set 30. At this point, the generator set 30 is driven to transform the input kinetic energy into electrical energy, which is sufficient for supplying to the light-emitting body 41 for the latter to emit light. In a most preferred embodiment of the present invention, the light-emitting body 41 is a light-emitting diode 411 that works with a double-layer capacity 436 providing a high capacity. When the pull ring 311 is pulled five times, the flashlight 10 may send out light for about 5 minutes.

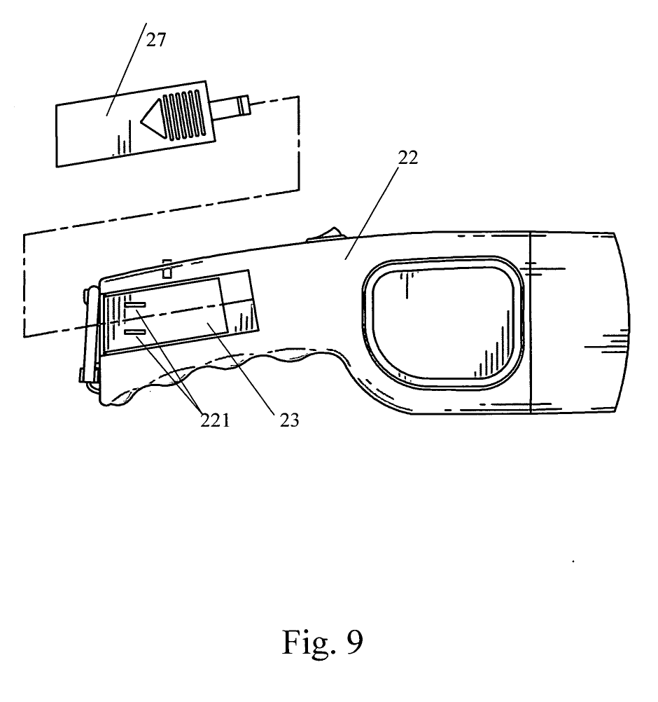

Please refer to FIG. 9. The self-generating flashlight 10 of the present invention may further include an accessory compartment cover 27 provided on the first shell 21. The cover 27 may be opened to expose an accessory clip 221 mounted on the second shell 22.

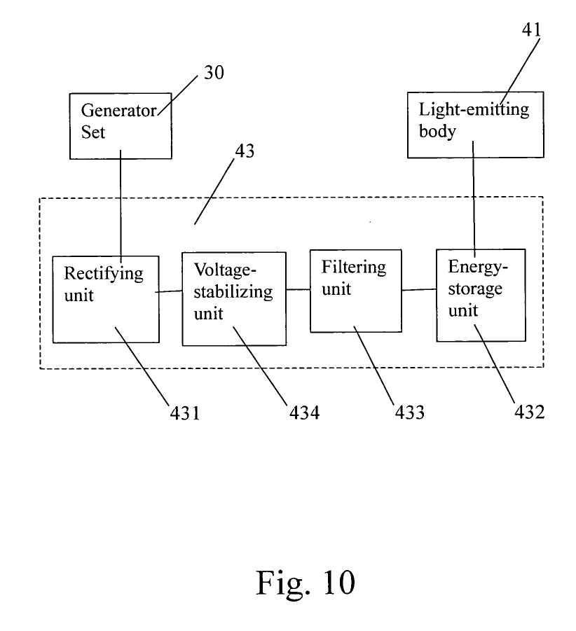

FIG. 10 is a block diagram of the present invention showing an electrical connection between the control circuit 43 and other components of the flashlight 10. The control circuit 43 mainly includes a rectifying unit 431, an energy-storage unit 432, a filtering unit 433, and a voltage-stabilizing unit 434. As mentioned before, the electric wires 44 connect the control circuit 43 of the lighting set 40 with the generator set 30, so that electric energy generated by the generator set 30 is sent to the rectifying unit 431 of the control circuit 43 via the electric wires 44. The electric energy is rectified at the rectifying unit 431 and then passed through the voltage-stabilizing unit 434 and the filtering unit 433 to be stored in the energy-storage unit 432. The electric energy stored in the energy-storage unit 432 is then transmitted to the light-emitting body 41, which may be one or more light-emitting diodes 411 or bulbs 412. The energy-storage unit 432 may be a capacitor 435 or a double-layer capacity 436 providing a high capacity.

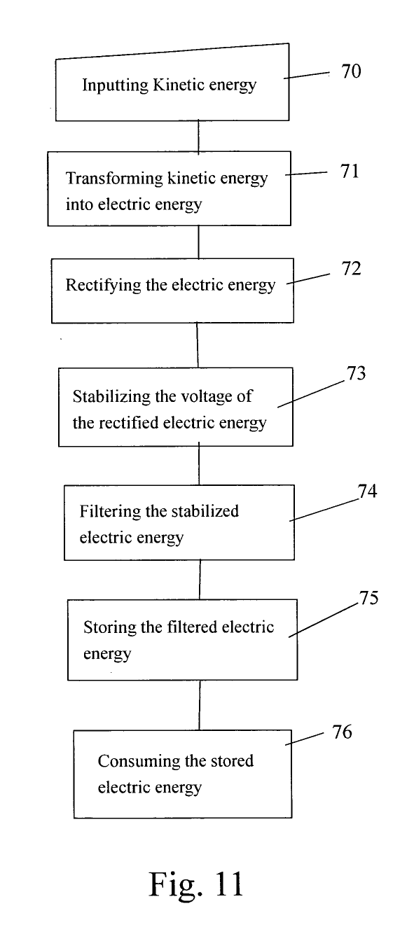

FIG. 11 is a flowchart showing operating procedures of the flashlight 10 to transform kinetic energy into electric energy. As shown, the operating procedures of the flashlight 10 mainly includes inputting a kinetic energy (step 70), transforming the kinetic energy into an electric energy (step 71), rectifying the electric energy (step 72), stabilizing the voltage of the rectified electric energy (step 73), filtering the stabilized electric energy (step 74), storing the filtered electric energy (step 75), and consuming the stored electric energy (step 76).

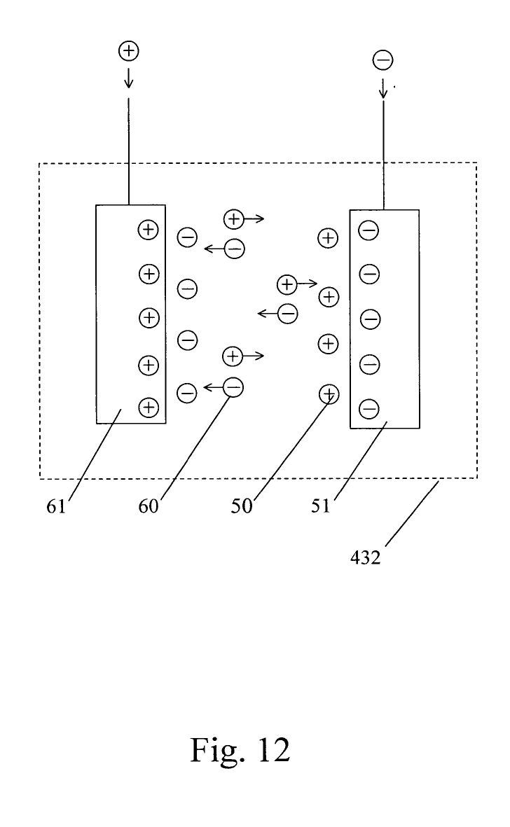

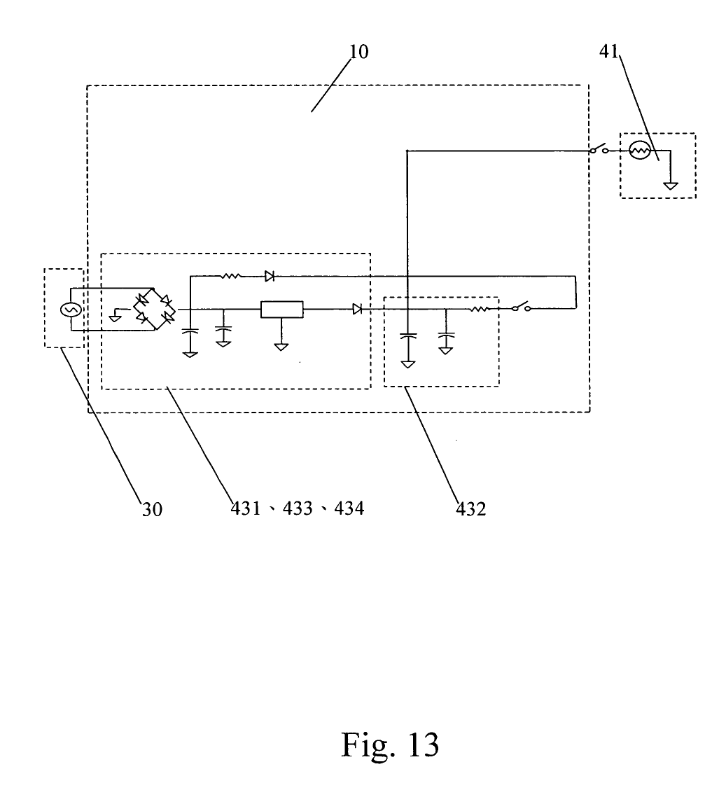

Please refer to FIGS. 12, 13 along with FIGS. 10 and 11. FIG. 12 corresponds to the step 75 of FIG. 11 and shows the manner in which the flashlight 10 is charged, that is, the manner in which the energy-storage unit 432 of the control circuit 43 operates. As shown, when an electric energy is input to the energy-storage unit 432, positive charges 50 of the electric energy will move to a positive electrode 51 of the energy-storage unit 432 while negative charges 60 move to a negative electrode 61. The energy-storage unit 432 may be a capacitor 435 or a double-layer capacity 436 providing a high capacity.

In brief, the flashlight 10 of the present invention is a self-generating flashlight, from which a wide range of applications may be derived. Moreover, the self-generating flashlight 10 has simple structure and may therefore be freely employed as a teaching aid in experimental courses. Or, the flashlight 10 may be sold in a disassembled manner for a consumer to enjoy the fun of assembling the flashlight by himself. In this manner, the flashlight 10 of the present invention may be mass-produced and sold at reduced cost to create high industrial value.

The present invention has been described with a preferred embodiment thereof and it is understood that many changes and modifications in the described embodiment can be carried out without departing from the scope and the spirit of the invention that is to be limited only by the appended claims.

1. A self-generating flashlight, comprising:
a housing defining an inner space therein;
a generator set being mounted in said inner space defined in said housing, and including a hand-pulled starter cord having a pull ring connected to an outer end thereof, said pull ring being normally bearing against a rear end of said housing; and
a lighting set including a light-emitting body, a control switch, and a control circuit, and being electrically connected to said generator set via one or more electric wires;
whereby when said pull ring is pulled to draw said hand-pull starter cord, said generator set is driven to generate an electric power, which is supplied to said light-emitting body via said electric wires, so that said light-emitting body emits light.

2. The self-generating flashlight as claimed in claim 1, wherein said housing is formed from mated first and second shell.

3. The self-generating flashlight as claimed in claim 1, wherein said housing is further provided at a predetermined position with a control switch opening, and at a front end with a lampshade, and is formed at a rear part into a handle.

4. The self-generating flashlight as claimed in claim 2, wherein said second shell of said housing is provided at a predetermined position with an accessory clip.

5. The self-generating flashlight as claimed in claim 3, wherein said housing further includes a reflection mirror mounted behind said lampshade.

6. The self-generating flashlight as claimed in claim 1, wherein said generator set includes a power-generating member, a flywheel, a transmission shaft, a relay ratchet, a first casing, a second casing, and a driving wheel.

7. The self-generating flashlight as claimed in claim 6, wherein said power-generating member includes more than one contact, to which said electric wires are electrically connected and thereby connect said generator set to said control circuit.

8. The self-generating flashlight as claimed in claim 1, wherein said light-emitting body comprises one or more light-emitting diodes.

9. The self-generating flashlight as claimed in claim 1, wherein said control circuit includes a rectifying unit, an energy-storage unit, a filtering unit, and a voltage-stabilizing unit.

10. The self-generating flashlight as claimed in claim 9, wherein said energy-storage comprises a double-layer capacity providing high capacity.
